(19) United States
(12) Patent Application Publication
(10) Pub. No.: US 2002/0175476 A1
(43) Pub. Date: Nov. 28, 2002

(54) Piston ring, and combined structure of piston ring and ring groove of piston

(75) Inventors: Minako Chinou, Saitama-shi (JP); Katsuaki Ogawa, Saitama-shi (JP); Takahiro Okazaki, Saitama-shi (JP)

Correspondence Address: PARKHURST & WENDEL, L.L.P., 1421 PRINCE STREET, SUITE 210, ALEXANDRIA, VA, 22314-2805, US

(73) Assignee: Nippon Piston Ring Co., Ltd., Saitama-shi (JP)

(21) Appl. No.: 10/102,923

(22) Filed: Mar. 22, 2002

(30) Foreign Application Priority Data
Mar. 30, 2001 (JP) 2001-098381
Jul. 31, 2001 (JP) 2001-232803

(51) Int. Cl. F02F 5/00

(52) U.S. Cl. 277/440

(57) ABSTRACT

The present invention provides a piston ring and a combined structure of a piston ring and a ring groove of piston having a hard carbon film which is excellent in wear resistance, scuffing resistance, cohesion resistance relative to the piston material and in peeling resistance. The above-mentioned object of the invention is achieved by continuously forming a hard carbon film 2 containing one or more elements selected from Si, W and Ni, or all of the outer peripheral surface 4, the inner peripheral surface 5, the top surface 6 and the bottom surface 7 of the piston ring 1. The hard carbon film contains Si and has an Si-containing film serving as a primer film for the hard carbon film. A Cr film should preferably be formed as primer film for the hard carbon film. It is desirable to have an ion-plating film as a primer film formed on the outer peripheral surface of the piston ring. The combined structure of the piston ring and the ring groove of the invention comprises the aforementioned piston ring and a ring groove made of steel or an aluminum alloy.

### BACKGROUND OF THE INVENTION

1. Field of the Invention

The present invention relates to a piston ring, and a combined structure of a piston ring and a ring groove of piston. More particularly, the invention relates to a piston ring, and a combined structure of piston ring and a ring groove of piston having a hard carbon film excellent in wear resistance, scuffing resistance, cohesion resistance and peeling resistance, formed on a piston material.

2. Description of the Related Art

Along with the recent tendency toward internal-combustion engine lighter in weight giving a higher output, piston rings are required to have higher sliding properties (for example, wear resistance, scuffing resistance and partner attacking resistance).

To improve wear resistance and scuffing resistance under these circumstances, a Cr plating film or a nitride layer is formed on the outer periphery, top or bottom surface of a piston ring. More recently, it is the common practice to adopt a hard film of CrN (chromium nitride) or TiN (titanium nitride) prepared by the PVD (physical vapor deposition) process in place of a Cr plating film or a nitrided layer for the purpose of further improving the aforementioned sliding properties.

However, when a piston ring groove (hereinafter simply referred to as a “ring groove”) is made of an Al alloy as in a gasoline engine, in which the top and bottom surfaces repeat collision with the inner surface of the ring groove at high temperatures, a Cr plating film, a nitrided layer or a hard film formed by the PVD process on the top and bottom surfaces of the piston ring attacks the ring groove made of an Al alloy. As a result, the piston ring having the hard film formed thereon suffers from a trouble known as an “Al cohesion” in which the Al alloy coagulates on the top and bottom surfaces of the piston ring, and this may cause an increase in wear of the ring groove.

When a steel piston is used as in a high-output high-load diesel engine, the aforementioned conventional piston ring having a hard film formed thereon may suffer from a steel cohesion phenomenon caused by a large thermal load.

To solve these problems, Japanese Unexamined Patent Application Publications Nos. 11-166625 and 12-120869 disclose inhibition of Al coagulating phenomenon caused on a ring groove made of an Al alloy by means of a piston ring having hard carbon films (also known as “diamond-like carbon films”) formed on the top and bottom surfaces. The European Patent EPO759519 Publication discloses inhibition of the Al cohesion phenomenon in a ring groove made of an A1 alloy with a piston ring having hard carbon films not containing a metal constituent (a-c:H structure) formed thereon.

However, the piston rings having the hard carbon films on the top and bottom surfaces or on the outer peripheral surface, as disclosed in the above-mentioned Japanese Unexamined Patent Application Publications Nos. 11-166625 and 12-120869 and the European Patent EPO759519 are insufficient in peeling resistance and adhesion of the hard carbon film during sliding, and have a problem in that cracks and/or breakage, and even peeling tend to occur in the hard carbon film in service.

Particularly, the piston ring disclosed in the European Patent EPO759519 involves problems of a high internal stress and a poor adhesion of the hard carbon film.

### SUMMARY OF THE INVENTION

Accordingly, it is an object of the present invention to provide means for solving the aforementioned problems, i.e., to provide a piston ring and a combined structure of a piston ring and a ring groove of piston, having a hard carbon film excellent in wear resistance, scuffing resistance, cohesion resistance and peeling resistance relative to the piston material, formed thereon.

To solve the aforementioned problems, in the piston ring of the present invention, a hard carbon film containing one or more elements selected from the group consisting of Si, W and Ni is directly and continuously formed, via a primer film, on all the surfaces of a piston ring including an outer peripheral surface, an inner peripheral surface, a top surface and a bottom surface thereof.

According to the invention, the above-mentioned hard carbon film is continuously formed on all the surfaces of the piston ring. There are therefore a fewer starting points for occurrence of cracks and/or breakage of the hard carbon film in service, thus making it possible to very largely improve peeling resistance of the formed hard carbon film. As a result, even for use for a long period of time, it is possible to provide a piston ring excellent in wear resistance, scuffing resistance and cohesion resistance. This piston ring of the invention is suitably applicable to a ring groove made of an Al alloy or a steel ring groove, and is therefore suitably applicable for a high-output high-load diesel engine.

In the piston ring of the invention, (a) the aforementioned hard carbon film should preferably contain Si, and an Si-containing film should preferably be formed as a primer film of the hard carbon film; and (b) the above-mentioned hard carbon film should preferably contain W or W—Ni, and a Cr film should preferably be formed as a primer film of the hard carbon film.

In the present invention, the hard carbon film is formed via the primer film or directly on the piston ring. Applicable primer films include: (1) an Si-containing film or a Cr film provided as a primer of the hard carbon film for the purpose of improving adhesion of the hard carbon film; and (2) a hard film provided on at least an outer peripheral surface of the piston ring material for improving wear resistance of the sliding surface of the piston ring (film formed by the ion plating process or the sputtering process from Cr—N, TiN, Cr—O—N, or Cr—B—N). The hard carbon film is provided via the primer film or directly, and a plurality of such films is laminated on the piston ring material.

As described above, it is possible to improve adhesion of the hard carbon film by forming a Si-containing film or a Cr film as a primer film of the hard carbon film. As a result, it is possible to prepare a piston ring excellent in peeling resistance, and to further improve sliding properties (wear resistance, scuffing resistance and inhibition of coagulating phenomenon) of the piston ring.

In the piston ring of the invention, it is desirable to form an ion-plating hard film in addition to the Si-containing film or the Cr film on at least the outer peripheral surface, or in place of the Si-containing film or the Cr film as a primer film. When the hard film is formed in place of the Si-containing or the Cr film, a hard ion-plating films are laminated on the piston ring base material, the Si-containing film or the Cr film are laminated thereon, and the hard carbon film is laminated thereon.

According to the present invention, because a hard and tough ion-plating film is formed as a primer film, it is possible to further improve wear resistance of at least the outer peripheral surface of the piston ring serving as a sliding surface.

The combined structure of a piston ring and a ring groove of piston of the invention comprises a piston ring having a hard carbon film containing one or more elements selected from the group consisting of Si, W and Ni directly and continuously formed, via a primer film, on all the surfaces of a piston ring including an outer peripheral surface, an inner peripheral surface, a top surface and a bottom surface thereof, and a ring groove made of steel or an aluminum alloy.

According to the invention, the piston ring having the above-mentioned hard carbon film continuously formed on all of the surface thereof very largely improve peeling resistance of the hard carbon film. The combined structure makes it difficult for a cohesion phenomenon to occur even after use for a long period of time. As a result, the invention is suitably applicable, not only for a gasoline engine, but also for a high-output high-load diesel engine.

### BRIEF DESCRIPTION OF THE DRAWINGS

FIG. 1 is a sectional view illustrating a typical piston ring of the present invention;

FIG. 2 is ;a sectional view illustrating another example of the piston ring of the invention;

FIG. 3 is a sectional view illustrating an example of the piston ring of the invention having a primer film 9 formed thereon;

FIG. 4 is a sectional view illustrating an example of the piston ring of the invention having a primer film (a primer film 9 and a primer film 3) formed thereon;

FIG. 5 illustrates an embodiment in which the Si content of the hard carbon film is inclined;

FIG. 6 gives (a) a plan view of the piston ring base material set on an attachment jig; and (b) a sectional view of a particular portion of the piston ring of the invention;

FIG. 7 is a sectional view illustrating the combined structure of the piston ring and the ring groove of the invention;

FIG. 8 illustrates an improved tester of the NPR-type impact test apparatus; and

FIG. 9 illustrates a high-temperature valve seat wear tester.

### DESCRIPTION OF THE PREFERRED EMBODIMENTS

The piston ring and the combined structure of a piston ring and a ring groove of the present invention will now be described with reference to the drawings.

### (1) Piston Ring

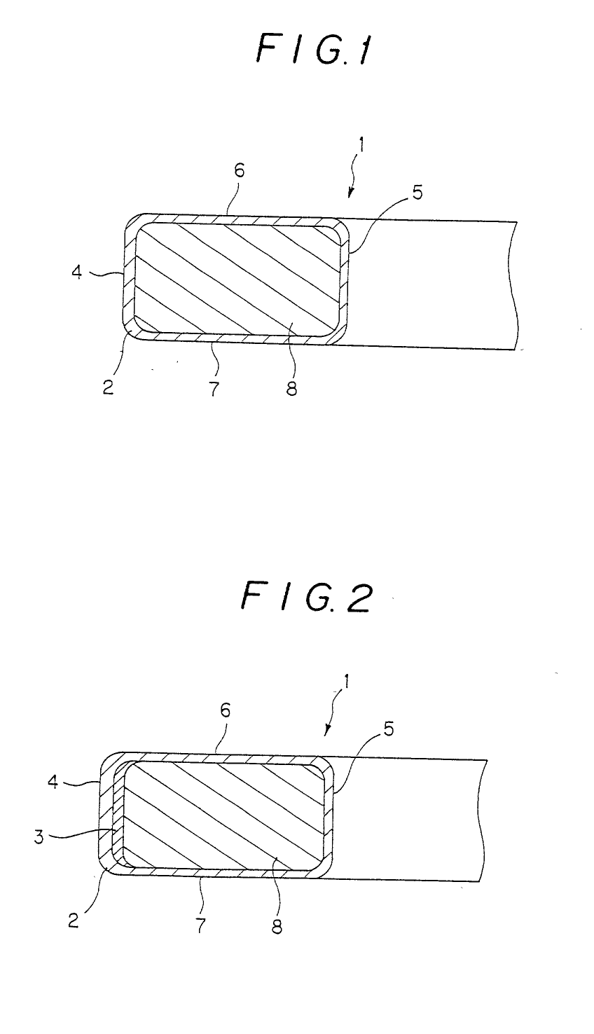

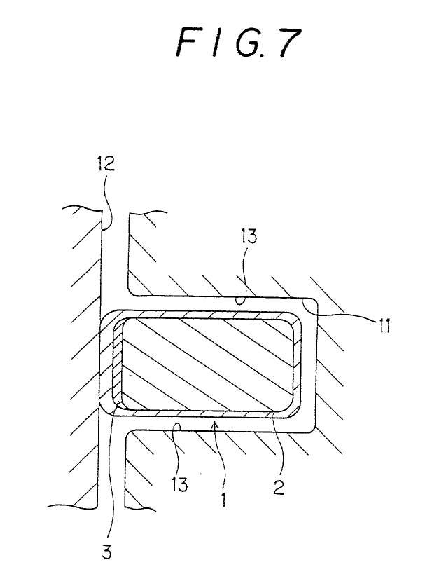

The piston ring 1 of the invention has, as shown in FIGS. 1 and 2, a hard carbon film 2 continuously formed on all the surfaces including an outer peripheral surface 4, an inner peripheral surface 5, a top surface 6 and a bottom surface 7. As shown in FIG. 7, the piston ring 1 is a sliding member which is attached to a ring groove 11 of piston, in sliding contact with the inner peripheral surface of a cylinder liner 12 under the effect of vertical movement (same as reciprocation) of the piston, and makes vertical movement while being tapped by the upper and lower (side) surfaces 13 of the ring groove 11.

The piston ring 1 of the invention may be any or all of a top ring, a second ring and an oil ring. It is particularly suitably applicable for the top ring.

The material for the piston ring 1 on which the hard carbon film 2 is formed may be one conventionally used, and no particular restriction is imposed thereon. The invention is therefore applicable to a piston ring 1 made of any materials such as stainless steel, a casting, a steel casting and steel which have conventionally been used popularly.

From among these materials, steel is more suitably applicable than casting. A steel is desirable because, when forming a hard carbon film 2 by the CVD process on a casting, gases produced in blowholes deteriorates the atmosphere and exerts an adverse effect on formation of the hard carbon film. Applicable steel materials include martensite stainless steel (SUS410 and SUS440, as specified in JIS Standard), austenite stainless steel (SUS304), and Si—Cr steel.

Since the hard carbon film 2 is formed over the entire periphery, the piston ring of the invention contains only a few starting points for occurrence of cracks and/or breakage, thus permitting remarkable improvement of peeling resistance of the hard carbon film 2. The hard carbon film 2 has also a function of inhibiting Al cohesion phenomenon and steel cohesion phenomenon under a high load, and a function of improving wear resistance and scuffing resistance. By using the piston ring of the invention, therefore, it is possible to achieve excellent wear resistance and scuffing resistance and inhibition of Al cohesion phenomenon and steel cohesion phenomenon under a high load, for a long period of time.

The hard carbon film 2 is formed by the PVD process such as the reactive ion plating process of the reactive sputtering process. It may be formed by the CVD process such as the plasma CVD process.

In the formation of the hard carbon film 2, the hard carbon film is positively formed on the top, bottom and inner peripheral surfaces. For this purpose, piston ring material pieces are attached at certain intervals on a jig, and then, the hard carbon film 2 is formed. Atoms having passed through gaps between the piston ring material pieces are therefore precipitated on the top, bottom and inner peripheral surfaces. Differences in thickness may therefore result between different surfaces, depending upon the gaps. Especially, when a film is formed while being attached to the jig in a chamber of, for example, a reactive ion plating apparatus or a reactive sputtering apparatus as in the case of the piston ring 1 of the invention, the hard carbon film formed on the outer peripheral surface of the piston ring tends to be the thickest, then followed by the top surface 6 and the bottom surface 7, and the inner peripheral surface 5 tends to be the thinnest. This difference in thickness can be controlled by adjusting the gap of the adjacent piston rings 1 upon attaching the piston ring 1 to the jig. For example, the difference in thickness between surfaces can be reduced by enlarging the gap, and increased by reducing the gap. The advantages of the piston ring of the invention can be achieved by selecting a gap between piston rings of about 10 mm, and adjusting the thickness of the individual surfaces through a change in the size of the gap.

The hard carbon film 2 contains one or more elements selected from the group consisting of Si, W and Ni. The resultant hard carbon film 2 may contain such elements as Si, W and Ni, may contain carbides such as SiC and WC, or may contain both these elements such as Si, W and Ni and carbides such as SiC and WC. By forming such a hard carbon film, it is possible to construct a piston ring 1 excellent in wear resistance and scuffing resistance. Since the hard carbon film 2 has a function of inhibiting cohesion phenomenon, the piston ring of the invention has an excellent property making it difficult for Al cohesion or steel cohesion to occur even when the top and bottom surfaces 6 and 7 and the inner peripheral surface 5 of the piston ring 1 of the present invention come into contact with the upper and lower surfaces (side surfaces) 13 of the ring groove 11 made of an A1 alloy or steel.

The basic structure of the hard carbon film is known to be an amorphous structure comprising the same carbon sp3 coupling as that of natural diamond, the same carbon sp2 coupling as that of graphite, and hydrogen coupling. The hard carbon film 2 of the invention has as well such a basic structure.

There is no particular restriction imposed on the composition of the hard carbon film 2. In the case of a W—Ni-based hard carbon film 2, for example, the composition should preferably comprise from 55 to 85 wt. %, or more preferably, from 60 to 80 wt. % W, from 3 to 10 wt. %, or more preferably, from 5 to 8 wt. % Ni, and the balance C and incidental impurities. In the case of an Si-based hard carbon film 2, the composition should preferably comprise from 50 to 70 wt.%, or more preferably, from 55 to 65 wt. % Si, and the balance C and incidental impurities. In the case of a W-based hard carbon film 2, the composition should preferably comprise from 50 to 85 wt. %, or more preferably, from 60 to 80 wt. % W, and the balance C and incidental impurities.

Containing Si in the hard carbon film improves forming ability of the film and facilitates increasing the film thickness. Containing W in the hard carbon film alleviates stress upon forming the film and facilitates forming of the film. Ni, which is sometimes contained in the W target for forming the hard carbon film, is an element tending to be contained in the hard carbon film 2. A target containing Ni is advantageous from the point of view of cost reduction.

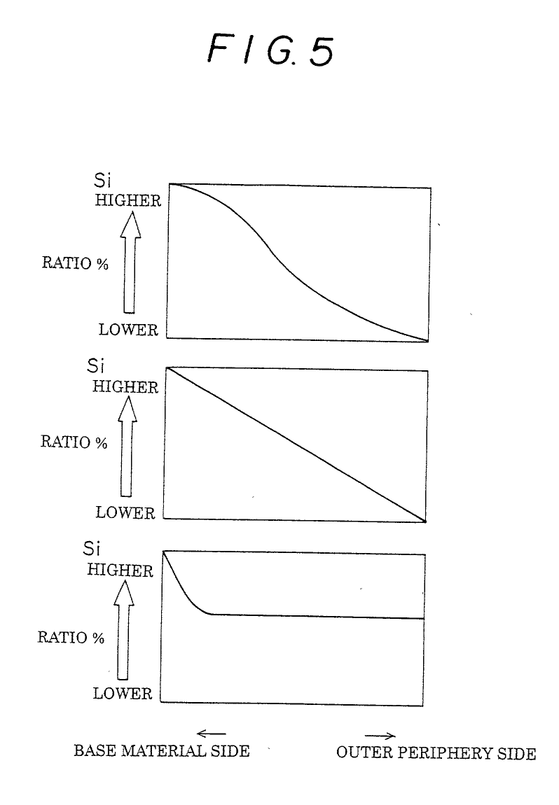

FIG. 5 illustrates an embodiment in which the Si content in an Si-based hard carbon film is directed toward a larger thickness. As shown in FIG. 5, the Si content can be changed in a curve shape or straight so as to be higher from the surface side toward the base material 8 side. It is furthermore possible to achieve a composition in which the Si content is higher only on the base material side and is constant in the other areas. Such a change is achieved by controlling the gas pressure during film formation. More specifically, the Si content can be increased by changing the mixing ratio of silane gas to acetylene gas so as to increase the ratio of silane gas. In contrast, the Si content can be reduced by changing the mixing ratio so as to increase the ratio of acetylene gas. As described later, adhesion of the Si-based hard carbon film can remarkably be improved by forming an Si-containing film as a primer film 9 of the hard carbon film.

The Si-containing film is formed so that the Si content is within a range of from about 70 to 100 wt. %. The Si-based hard carbon film formed thereon should preferably have an Si content on the primer film side within a range of from 70 to 100 wt. %, thus permitting remarkable improvement of adhesion. In this case, the Si content of the Si-based hard carbon film on the outermost surface side is reduced to a value within a range of from about 0 to 70 wt. %.

The thickness of the hard carbon film 2 formed on the inner peripheral surface 5 of the piston ring 1 should preferably be at least 0.01 μm. The piston ring 1 having a hard carbon film thicker than 0.01 μm formed on the inner peripheral surface 5 bring about remarkable improvement of peeling resistance of the hard carbon film 2, thus permitting achievement of the planned object of the present invention.

Since the thickness of the hard carbon film 2 formed on the inner peripheral surface 5 can be increased by enlarging the gap as described above, it is possible to appropriately adjust the difference in thickness between the outer peripheral surface 4 and the top and bottom surfaces 6 and 7. It is possible to provide an upper limit of about 30 μm for the thickness on the inner peripheral surface.

The hard carbon film 2 formed on the top surface 6 and the bottom surface 7 of the piston ring 1 should preferably have a thickness within a range of from 1 to 30 μm. The thickness range of from 1 to 30 μm for the hard carbon film 2 is adopted in consideration of Al cohesion resistance or steel cohesion resistance relative to the ring groove 11, wear resistance and scuffing resistance and from the manufacturing point of view. More specifically, with a thickness of the hard carbon film 2 formed on the top surface 6 and the bottom surface 7 of under 1 μm, the small thickness of the film does not sometimes permit improvement of wear resistance between the top and bottom surfaces (side surfaces) 13 of the ring groove 11. A thickness of the hard carbon film 2 formed on the top and bottom surfaces of under 30 μm may cause occurrence of peeling of the formed hard carbon film 2.

In the present invention, when the top surface and the bottom surface having thickness within the above-mentioned range is assumed to be 100 (index), the outer peripheral surface 4 should preferably have a thickness within a range of from 100 to 500 (index), or more preferably, from 120 to 300 (index). The inner peripheral surface should preferably have a thickness within a range of from 1 to 99 (index), or more preferably, from 30 to 90 (index). It is therefore possible to form the outer peripheral surface with a thickness within a range of from 1 to 150 μm, or more preferably, from 1.2 to 90 μm.

By continuously forming this hard carbon film 2 over the entire periphery of the piston ring, even when the piston ring 1 is attached to the piston, the number of starting points for occurrence of cracks and/or breakage is reduced, and peeling resistance of the hard carbon film 2 can be improved. As a result, it is possible to provide a piston ring which is excellent in wear resistance and scuffing resistance and permits inhibition of Al cohesion phenomenon or steel cohesion phenomenon, even for use for a long period of time.

In the piston ring 1 of the present invention, there is available an advantage of solving the problem of soot deposition caused by oil combustion during sliding of the piston ring 1. In the conventional art, soot produced from oil burning caused between the piston ring 1 and the ring groove 11 deposits or coagulates on the bottom surface 7 of the piston ring or the inner peripheral surface 5 thereof, and this may sometimes constrains the piston ring. This is serious in the case of a rectangular piston ring in which soot easily accumulates in the space between the piston ring and the ring groove.

This is also the case with a half keystone ring or a full keystone ring suitably used in a diesel engine. In respect of this problem deposition, the piston ring 1 of the invention, having the hard carbon film 2 formed on the bottom surface 7 and the inner peripheral surface 5 where the soot problem tend to be encountered over the entire periphery, makes it difficult for soot to adhere, and deposited soot, if any, can easily be crushed, thus facilitating exclusion of soot. As a result, there are available remarkable advantages in that it is possible to prevent deposition of soot, prevent constraint of the piston ring, and prevent an abnormal increase in back pressure.

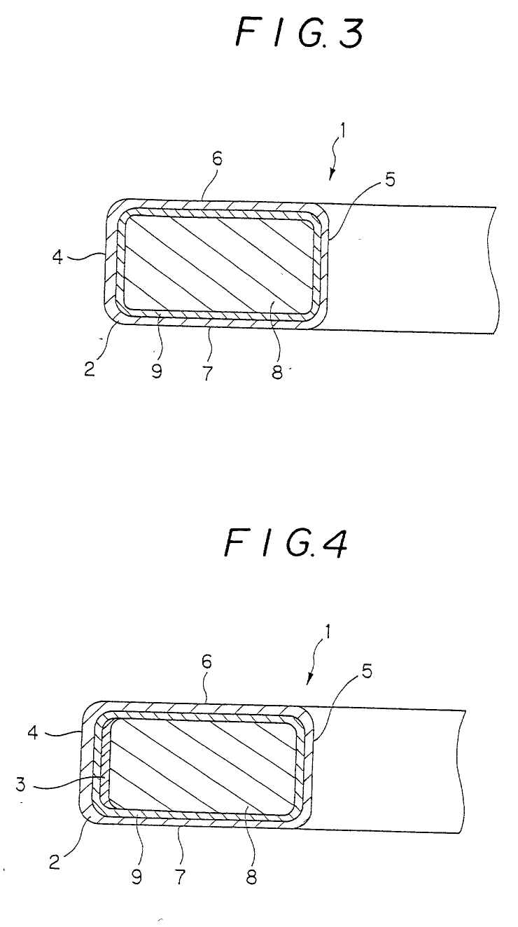

As shown in FIG. 3, it is desirable that an Si-containing or Cr film is formed as a primer film 9 of the hard carbon film 2.

The Si-containing film should preferably be formed on the steel serving as the piston ring base material so that the Si content is within a range of from 70 to 100 wt. % as described above. By forming an Si-based hard carbon film thereon, it is possible to remarkably improve adhesion of the hard carbon film. As the Cr film, it is desirable to form a Cr film or a film substantially comprising Cr on the steel serving as the piston ring base material. By forming a W-based or W—Ni-based hard carbon film thereon, adhesion of the hard carbon film can be remarkably improved. The Si-containing film may comprise SiC, a mixture of Si and C, or a mixture of these three materials. The film substantially comprising Cr may contain incidental impurities.

Under the effect of these Si-containing film or the Cr film, it is possible to improve adhesion between the primer piston ring base material 8 and the hard carbon film 2, thereby improving peeling resistance. As a result, it is possible to further improve wear resistance and scuffing resistance of the piston ring and inhibiting effect of cohesion phenomenon.

The Si-containing film or the Cr film serving as the primer film 9 should preferably be formed by the sputtering process, the ion plating process or the plating process in response to the kind of film. The thickness of the primer film 9 should preferably be within a range of from 0.1 to 5 μm.

On at least the outer peripheral surface 4 of the piston ring 1, it is desirable to form a primer film comprising a hard film (hereinafter referred to as a “hard film 3”) as shown in FIGS. 2 and 4.

The primer film 3 should preferably be a film formed by the ion plating process (this is referred to as an “ion plating film” in the present invention), particularly a Cr—N, TiN, CrO—N or Cr—B—N hard film is preferable. Such an ion plating film, which is hard and tough, can improve wear resistance and scuffing resistance of the outer peripheral surface 4 of the piston ring 1, serving as a sliding surface. The hard film 3 may be formed by a thin-film forming process such as the reactive sputtering process in place of the ion plating process. This hard film 3 should preferably have a thickness within a range of from 5 to 50 μm.

A method of manufacturing the piston ring of the invention will now be described.

The hard carbon film 2 directly and continuously formed via the primer film on the entire periphery of the piston ring, i.e., on the outer peripheral surface 4, the inner peripheral surface 5, the top surface 6 and the bottom surface 7 of the piston ring is formed by a PVD process such as the reactive ion plating process or the reactive sputtering process, or a CVD process.

In an embodiment of forming a hard carbon film by sputtering, the process comprises the steps of first setting a piston ring base material 8 onto an attachment jig in a chamber of a reactive sputtering apparatus, evacuating the chamber, then introducing an inert gas such as argon while rotating the attachment jig, and cleaning the surface of the piston ring base material through ion bombardment. The subsequent steps comprise sputtering a Cr target with ionized argon or the like, causing precipitation of vaporized Cr atoms in the chamber onto the piston ring base material 8, then introducing a hydrocarbon-based gas such as methane serving as a carbon source into the chamber, sputtering a metal target containing one or more elements selected from Si, W and Ni by means of ionized argon or the like, and forming a hard carbon film 2 on the piston ring base material 8 in which Cr atoms have been precipitated through coupling of carbon atoms and vaporized metal atoms in the chamber. The content of one or more elements selected from Si, W and Ni is controlled by adjusting the vaporization rate of these elements and the pressure of the reactive gas.

Another embodiment of forming a hard carbon film by the CVD process comprises the steps of first setting a piston ring base material 8 onto an attachment jig in a chamber of a plasma CVD apparatus, evacuating the chamber, then introducing an inert gas such as argon while rotating the attachment jig, cleaning the surface of the piston ring base material 8 through ion bombardment, subsequently introducing a hydrocarbon gas such as acetylene gas serving as a carbon source into the chamber, activating the same with plasma by introducing silane gas or the like containing Si, and causing precipitation of a combination of carbon atoms and vaporized metal atoms in the chamber in the form of a film containing at least Si on the piston ring base material 8, thereby forming a hard carbon film 2. The Si content is controlled by adjusting the pressure of the reactive gas containing Si element.

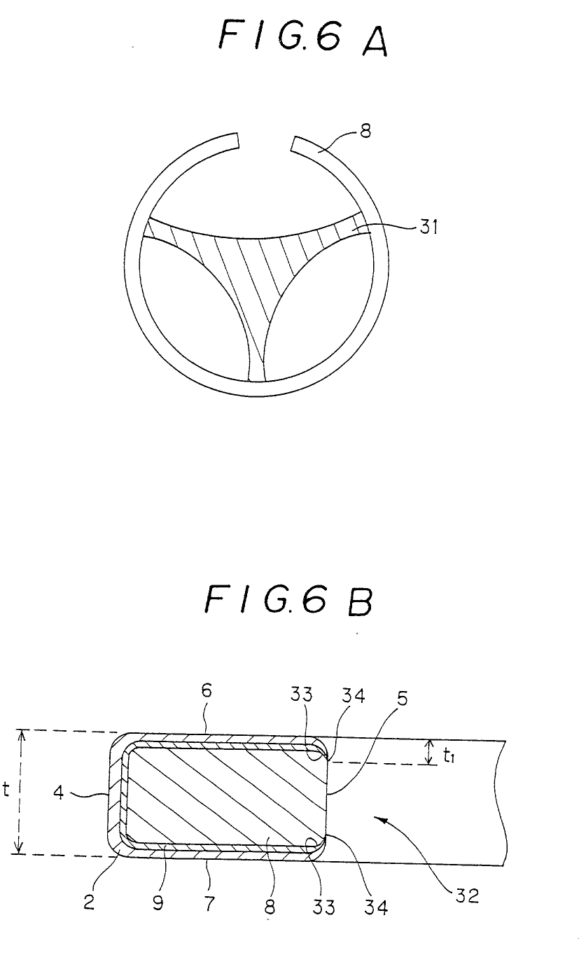

FIG. 6 illustrates a plan view (a) of a piston ring base material set on an attachment jig, and a sectional view (b) of a specific portion of the piston ring of the present invention. As described above, the piston ring base material 8 is on the attachment jig 31 in the chamber. As is known from these schematic views, the piston ring base material 8 can be held by internally lining the piston ring base material 8 by means of the attachment jig 31. The thus held piston ring base material 8 is set by holding the same in a state slightly larger than the free abutment gap (meaning a gap of the abutment portion in a free state). For some shapes of the attachment jig 31, it may come into contact with the inner peripheral surface 5 of the piston ring base material 8 as shown in FIG. 6(a). When a hard film 3, a primer film 9 and the hard carbon film 2 are formed on the piston ring base material 8 set in such a contact state, these films are not formed in some cases because of problems in manufacture on the inner peripheral surface 5 of the piston ring in contact with the attachment jig 31 (see FIG. 6(b)). A shape of the attachment jig is not limited to one as shown in FIG. 6(b) but can be altered in an appropriate manner by taking a cost of manufacture and a life in use, etc. into consideration.

However, in the piston ring of the present invention, even when it has a portion not having a primer film 9 or a hard carbon film 2 on a part of the inner peripheral surface 5 (hereinafter referred to as a “specific portion 32”), has a hard carbon film 2 continuously formed on the entire ring. As a result, since the hard carbon film 2 is continuously formed on the entire periphery of the piston ring except for the specific portion, this piston ring having such a specific portion can display advantages of the invention, and is therefore included in the technical scope of the invention, and can improve peeling resistance of the hard carbon film

At this point in time, as shown in FIG. 6(b), the hard carbon film 2 is formed so as to go around in the center direction of the inner peripheral surface from a corner 33 on the inner peripheral surface at his specific portion 32 (the portion not having the hard carbon film 2 formed over the entire inner peripheral surface 5 by the attachment jig). The ratio of going around from each corner 33 in the center direction of the inner peripheral surface 5 should preferably be such that the ratio (t1/t) of the thickness t of the piston ring 1 to the length t1 of going around from an upper or lower corner in the center direction is at least 1/10. That is, t1 should preferably be at least 10% of the thickness t of the entire piston ring 1. The hard carbon film 2 formed in the manner as described above can hardly become a starting point for peeling even under impact upon sliding because the boundary line 34 of formation of the hard carbon film 2 is closer to the center of the inner peripheral surface 5 than the corner 33. As a result, a piston ring having a few such 32 (for example, two or three) is provided with a high peeling resistance. It is needless to mention that the most desirable is the one not containing a specific portion and having a hard carbon film covering the entire surface.

A piston ring 1 having an ion plating film, a hard film 3, serving as a primer film 3 on the outer peripheral surface 4 is prepared by previously forming a hard film 3 comprising a compound such as Cr—N, TiN, Cr—O—N or Cr—B—N by an ion plating apparatus, and then forming a hard carbon film by subjecting the same to the above-mentioned reactive sputtering apparatus. After forming the hard film 3, it is desirable to form an Si-containing film or a Cr film as a primer film 9 on the hard film 3, and form furthermore a hard carbon film 2 on this primer film 9 (see FIG. 4).

### (2) Combined Structure of Piston Ring and Ring Groove of Piston.

FIG. 7 is a configurational sectional view illustrating an example of the combined structure of a piston ring and a ring groove of piston.

The combined structure of a piston ring 1 and a ring groove 11 of piston comprises the above-mentioned piston ring of the invention and a ring groove 11 made of steel or an aluminum alloy. The characteristic configuration and advantages of the piston ring 1 are the same as those of the above-mentioned piston ring of the invention. In FIG. 7, reference numeral 12 represents a cylinder liner.

The above-mentioned piston ring 1 of the invention is suitably applicable to an Al alloy or steel piston. The piston ring 1 of the invention can of course be applied to an Al alloy piston of a cast-iron piston attached with a piston trigger believed to be resistant to cohesion phenomenon.

The Al alloy piston should preferably comprise an Al—Si—Ni—Cu—Mg alloy (for example, AC8A, AC8B or AC8C in JIS Standard symbols). This piston is the most popularly used and is prepared by standing casting.

The steel piston should preferably comprise a hot die steel used as hot tool steel, typically represented by SKD6 (JIS Standard). These steel materials provide advantages of softening resistance and secondary hardening. This piston is applied for a high-load diesel engine.

By attaching the piston ring 1 of the invention to the ring groove 11 formed on the aforementioned piston, it is possible to very effectively inhibit cohesion phenomenon between the ring groove and the piston ring 1.

### EXAMPLES

The present invention will now be described further in detail by means of examples and comparative examples.

### Example 1

A piston ring base material 8 made of 17Cr stainless steel was prepared. Then, an Si-based hard carbon film 2 was formed by means of a CVD apparatus over the entire periphery of the piston ring base material 8, i.e., on an outer peripheral surface 4, an inner peripheral surface 5, a stop surface and a bottom surface. A piston ring of Example 1 was thus prepared.

The Si-based hard carbon film 2 had a composition comprising 69.4 wt. % Si, and the balance C and incidental impurities, achieved by controlling reaction conditions such as the silane gas pressure. The thickness for the individual surfaces were: outer peripheral surface 4: 9.9 μm; inner peripheral surface 5: 6.5 μm; top surface 6: 7.5 μm; and bottom surface 7: 6.1 μm.

### Example 2

In the same manner as in Example 1, a hard film 3 (Cr—N film) having a thickness of 30 μm was formed by an ion plating apparatus on the outer peripheral surface 4 of a piston ring base material prior to forming an Si-based hard carbon film 2. Except for the above, a piston ring of Example 2 was prepared in the same manner as in Example 1.

A CrN film serving as an ion plating film having main orientation of {200} was formed by means of an ion plating apparatus. Then, the surface of the ion plating film was polished by using a polishing paper while making an adjustment so as to achieve a roughness of 1 μm Rz. The film had a final thickness of 20 μm. The thus formed ion plating film had a Vickers hardness of Hv 1,500.

### Example 3

A piston ring of Example 3 was prepared in the same manner as in Example 2 except that, after forming a hard film 3 (Cr—N film), an Si-containing film (Si: 72 wt % having a thickness of 1 μm serving as a primer film 9 was formed by means of CVD apparatus over the entire periphery of a piston ring base material 8 prior to forming an Si-based hard carbon film 2.

### Example 4

A piston ring of Example 4 was prepared in the same manner as in Example 1 except that, in place of forming an Si-based hard carbon film 2 over the entire periphery by means of a CVD apparatus, a W-based hard carbon film 2 was formed over the entire periphery by use of a reactive sputtering apparatus.

The W-based hard carbon film 2 was formed so as to have a composition comprising 75 wt. % W and the balance C and incidental impurities by controlling reaction conditions such as the W target and the carbon-containing gas pressure. The individual surfaces had the following thickness: outer peripheral surface 4: 2.1 μm; inner peripheral surface 5: 0.4 μm; top surface 6: 1.1 μm; and bottom surface 7: 0.7 μm.

### Example 5

A piston ring of Example 5 was prepared in the same manner as in Example 4 except that a hard film 3 (Cr—N film) having a thickness of 30 μm, by means of an ion plating apparatus, on an outer peripheral surface 4 of a piston ring base material 8 prior to forming a W-based hard carbon film 2.

The details of the ion plating film were the same as in Example 2.

### Example 6

A piston ring of Example 6 was prepared in the same manner as in Example 5 except that, after forming a hard film 3 (Cr—N film), a Cr film (Cr) having a thickness of 0.4 μm serving as a primer film 9 was formed by means of an ion plating apparatus over the entire periphery of a piston ring base material 8 prior to forming a W-based hard carbon film 2.

### Example 7

A piston ring of Example 7 was prepared in the same manner as in Example 1 except that, in place of forming an Si-based hard carbon film 2 by means of a CVD apparatus over the entire periphery, a W—Ni-based hard carbon film 2 was formed by use of a reactive sputtering apparatus.

The W—Ni-based hard carbon film 2 was formed so as to have a composition comprising 75 wt. % W, 8 wt. % Ni and the balance C and incidental impurities by controlling reaction conditions such as the W—Ni target and the carbon-containing gas pressure. The individual surface had the following thickness: outer peripheral surface 4: 2.1 μm; inner peripheral surface 5: 0.4 μm; top surface 6: 1.1 μm; and bottom surface: 0.7 μm.

### Example 8

A piston ring of Example 8 was prepared in the same manner as in Example 7 except that a hard film 3 (Cr—N film) having a thickness of 30 μm was formed by use of an ion plating apparatus on the outer peripheral surface 4 of a piston ring base material 8 prior to forming a W—Ni-based hard carbon film 2.

The details of the ion plating film were the same as in Example 2.

### Example 9

A piston ring of Example 9 was prepared in the same manner as in Example 8 except that, after forming a hard film 3 (Cr—N film), a Cr film (Cr) having a thickness of 0.4 μm serving as a primer film 9 was formed by use of an ion plating apparatus over the entire periphery of a piston ring base material 8 prior to forming a W-based hard carbon film 2.

### Comparative Example 1

A piston ring base material 8 was made of 17Cr stainless steel. Then, an Si-based hard carbon film 2 having a thickness of 6.5 μm was formed by means of CVD apparatus only on the stop surface 6 and the bottom surface 7. The Si-based hard carbon film 2 was formed so as to have a composition comprising 69.4 wt. % Si and the balance C and incidental impurities by controlling reaction conditions such as the silane gas pressure.

### Comparative Example 2

A piston ring base material 8 was made of 17Cr stainless steel. Then, a gas nitriding layer having a depth of 100 μm was formed, through a gas nitriding treatment, over the entire periphery of the piston ring base material 8. Subsequently, a hard film 3 (Cr—N film) was formed by use of an ion plating apparatus on the outer peripheral surface 4, thereby preparing a piston ring of

### Comparative Example 2

The gas nitriding treatment comprised the steps of holding the object in an ammonia decomposition gas atmosphere at 590° C. for six hours, and then holding the same at 540° C. for two hours, thereby forming the gas nitriding layer having the above-mentioned depth. Then, the surface of the nitriding layer was polished by use of a polishing paper, while making n adjustment so as to achieve a roughness of 1 μm Rz. The nitriding layer had a final depth of 70 μm. The thus formed gas nitriding layer had a Vickers hardness of Hv 1,100.

TABLE 1
Configurations of Examples 1 to 9 and Comparative Examples 1 and 2.

| | Configuration of Piston Ring 1 | | | | | |
|---|---|---|---|---|---|---|
| | | | Forming Surface and Kind of Hard C Film 2 | | | |
| | A | B | C | D | E | F |
| Example 1 | None | None | Si based | Si based | Si based | Si based |
| Example 2 | IP film | None | Si based | Si based | Si based | Si based |
| Example 3 | IP film | Si—C film | Si based | Si based | Si based | Si based |
| Example 4 | None | None | W based | W based | W based | W based |
| Example 5 | IP film | None | W based | W based | W based | W based |
| Example 6 | IP film | Cr film | W based | W based | W based | W based |
| Example 7 | None | None | W—Ni based | W—Ni based | W—Ni based | W—Ni based |
| Example 8 | IP film | None | W—Ni based | W—Ni based | W—Ni based | W—Ni based |
| Example 9 | IP film | Cr film | W—Ni based | W—Ni based | W—Ni based | W—Ni based |
| Comp. Ex 1 | None | None | None | None | Si based | Si based |
| Comp. Ex 2 | GN layer | None | IP film | None | None | None |

A: Primer Film 3 (Outer peripheral surface),
B: Primer Film 9 (Outer peripheral surface),
C: Outer peripheral surface,
D: Inner peripheral surface,
E: Top surface,
F: Bottom surface,
IP film: Ion Plating film (Cr—N),
GN layer: Gas nitriding layer (Wear test)

A wear test was carried out by using an Amsler wear tester, immersing about a half a test piece into an oil, bringing a counter-part into contact therewith, and applying a load. An Amsler test pieces subjected to the same treatments as the piston rings of Examples 1 to 9 and Comparative Example 2 were used. The wear test was conducted on each such test piece to evaluate wear resistance. The test was carried out with boron cast iron as a counter-part under test conditions including a lubricant oil of Cricef H8 (corresponding to #1 spindle oil), an oil temperature of 80° C., a circumferential speed of 1 m/second (478 rpm), a load of 150 kgf, and a test time of seven hours. The counter-part comprising boron cast iron was ground into a prescribed shape and sequentially surface-polished while changing fineness of a polishing grindstone by making adjustment so as to finally achieve 2 μm Rz. When resistance was evaluated in terms of the amount of wear (μm) measured on a stepped profile by use of a roughness meter.

The relative ratio of the amount of wear for each test piece corresponding to each of Examples 1 to 9 to the amount of wear of the test piece corresponding to Comparative Example 2 was used as a wear index to evaluate wear resistance. A smaller wear index of each test piece than 100 therefore represents a smaller amount of wear. The test pieces corresponding to Examples 1 to 9 showed wear indices within a range of from 105 to 108, which were on almost the same level as the result for the test piece corresponding to Comparative Example 2, causing no serious problem. The result is shown in Table 2.

### Scuffing Test

A scuffing test was carried out by using an Amsler wear tester, depositing a lubricant oil on the test piece, and applying a load until occurrence of scuff. Amsler test pieces subjected to the same treatments as the piston rings of Examples 1 to 9 and Comparative Example 2 were used. The scuffing test was conducted by use of these test pieces to evaluate scuffing resistance. The test was carried out with boron cast iron as a counter-part under test conditions including a lubricant oil of Cricef H8 (corresponding to #1 spindle oil), and a circumferential speed of 1 m/second (478 rpm). Adjustment was made for boron cast iron by the aforementioned method to finally achieve 2 μm Rz.

The relative ratio of the scuffing load of the individual test pieces corresponding to Examples 1 to 9 to that of 100 for the test piece corresponding to Comparative Example 2 was used as a scuffing resistance index to evaluate scuffing resistance. A larger scuffing resistance index of each test piece of those corresponding to Examples 1 to 9 than 100 therefore represents a larger scuffing load, suggesting a more excellent scuffing resistance than that of the test piece corresponding to Comparative Example 2. Scuffing indices for the test pieces corresponding to Examples 1 to 9 are within a range of from 110 to 200, which represent a far more excellent scuffing resistance than that of the test piece corresponding to Comparative example 2. The result is shown in Table 2.

### Peeling Resistance Test

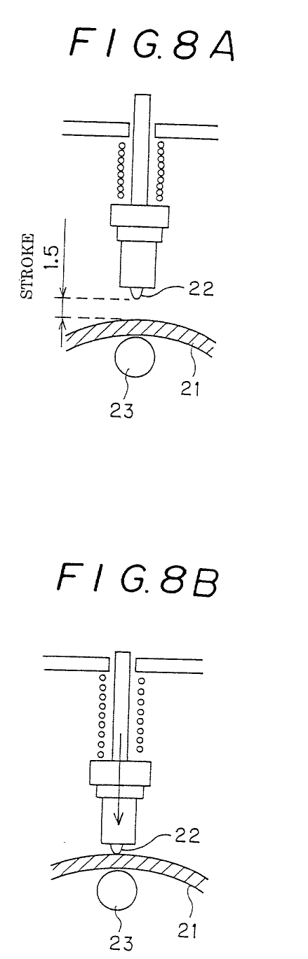

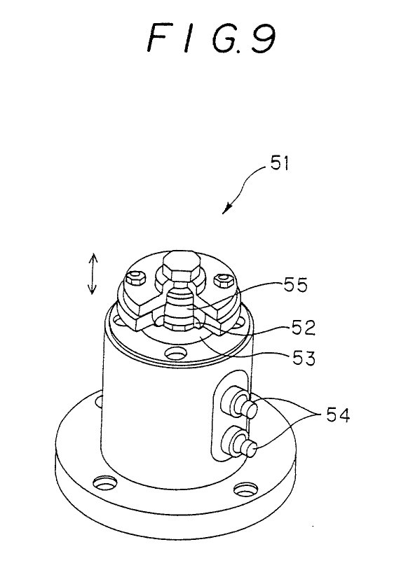

A peeling resistance was evaluated through a peeling resistance test carried out by use of an impact tester shown in FIG. 8 (in FIG. 8, 21 represents a piston ring; 22, a pressurizer; and 23, a strap), by applying an impact energy of 43.1 mJ (4.4 kgf.mm) per run onto the surface, in terms of the number of runs before occurrence of peeling. The piston rings of the above-mentioned Examples 1 to 9 and Comparative Example 1 were used as test pieces. The peeling resistance was carried out by use of these test pieces to evaluate peeling resistance. Presence of peeling was observed and evaluated by enlarging the surface to 15 magnifications.

Peeling resistance was evaluated by comparing the number of occurrences of peeling for the test pieces of Examples 1 to 9 in terms of the peeling resistance index relative to the result for comparative Example 1, assuming the number of occurrences of peeling for-the test piece of Comparative Example 1 to be 100. A peeling resistance index for the test pieces of Examples 1 to 9 larger than 100 would suggest a larger number of occurrences of peeling than that for the test piece of Comparative Example 1, showing a more excellent peeling resistance. The peeling resistance indices for examples 1 to 9 are within a range of from 110 to 120, suggesting a more excellent peeling resistance as compared with the piston ring of Comparative Example 1. The result is shown in Table 2.

### Stippling Test

A stippling test was carried out by use of a high-temperature valve seat wear tester 51 shown in FIG. 9. Sliding/stippling test pieces subjected to the same treatments as-in Examples 1 to 9 and Comparative Example 1 were used to evaluate the amount of stippling wear. Test conditions included a stroke of 4 mm; a repeat speed of 500 runs/minute; ring revolutions of 3 rpm; a test time of 10 hours; a piston material temperature of 340° C.; and a piston material of an A1 alloy (AC8A) and a steel material (SKD6 material). The presence of “cohesion” was observed and evaluated by enlarging the surface to 15 magnifications.

The term “sliding/stippling test” as used herein comprises the steps of fixing the piston material 53 immovably in the axial direction relative to the tester 51, concentrically attaching the piston ring material 52 to the piston material 53, and causing axial reciprocation of a round rod 55 made of cast iron corresponding to the cylinder liner provided on the inner peripheral surface side of the piston ring material 52. An operating mode of tapping the spindle material 53 is imparted while rotating the piston ring material 52. The tester 51 has a heater 54 for heating the object to be tested, permitting reproduction of the high-temperature state during combustion in an engine without the need to actually burning a fuel, thus enabling to simulate a change in the state of the piston material. By means of this test, the wear on the piston side (amount of wear of the piston material) and the wear on the piston ring side (amount of wear of the piston ring material) were evaluated.

The result was represented by wear indices for the top and bottom surfaces of the piston ring. The results of the individual test pieces of Examples 1 to 9 as wear indices were compared to the result of Comparative Example 2, by assuming the results of the amount of wear on the piston side and the amount of wear on the piston ring side of Comparative Example 1 to be 100. A smaller wear index for Examples 1 to 9 than 100 would therefore suggest a smaller amount of wear, and a more excellent wear resistance than Comparative Example 2. The piston-side wear indices and piston-ring-side wear indices for Examples 1 to 9 each having hard carbon films on the top and bottom surfaces are within a range of from 70 to 90, which represent a far more excellent wear resistance than that of the test piece of Comparative Example 2. The result is shown in Table 2.

TABLE 2

| | | | | Combined Structure of Piston Ring and Ring Groove | | | | | |
|---|---|---|---|---|---|---|---|---|---|
| | Piston Ring | | | Al alloy ring groove | | | Steel ring groove | | |
| | A | | B | F | G | | F | G | |
| | C | D | E | X | X | Y | X | X | Y |
| Example 1 | 108 | 200 | 110 | None | 80 | 80 | None | 90 | 70 |
| Example 2 | 108 | 200 | 110 | None | 80 | 80 | None | 90 | 70 |
| Example 3 | 108 | 200 | 120 | None | 80 | 80 | None | 90 | 70 |
| Example 4 | 105 | 110 | 110 | None | 80 | 80 | None | 90 | 70 |
| Example 5 | 105 | 110 | 110 | None | 80 | 80 | None | 90 | 70 |
| Example 6 | 105 | 110 | 120 | None | 80 | 80 | None | 90 | 70 |
| Example 7 | 105 | 110 | 110 | None | 80 | 80 | None | 90 | 70 |
| Example 8 | 105 | 110 | 110 | None | 80 | 80 | None | 90 | 70 |
| Example 9 | 105 | 110 | 120 | None | 80 | 80 | None | 90 | 70 |
| Comp. Ex.1 | — | — | 100 | None | 80 | 80 | None | 80 | 80 |
| Comp. Ex. 2 | 100 | 100 | — | Observed | 100 | 100 | Observed | 100 | 100 |

A: Outer peripheral sliding surface,
B: Entire peripheral surface,
C: Wear resistance index,
D: Scuffing resistance index,
B: Peering resistance index,
F: cohesion phenomenone,
G: Wear resistance index,
X: Top and bottom surface of Piston ring,
Y: Inner surface of ring groove

### Evaluation

In any of the piston rings of Examples 1 to 9, as compared with the piston ring of Comparative Example 2, no occurrence of cohesion was observed on the top surface or the bottom surface. Wear resistance for the top and bottom surfaces was largely improved. As a result of formation of the hard carbon film 2, wear resistance and scuffing resistance of the outer peripheral sliding surface, particularly scuffing resistance showed a remarkable improvement. Formation of the hard carbon film 2 over the entire peripheral surface brought about an excellent peeling resistance.

According to the piston ring and the combined structure of a piston ring and a ring groove of the present invention, as described above, a hard carbon film is continuously formed on all the surfaces of the piston ring. There are therefore only a few starting points in the hard carbon film for occurrence of cracks and/or breakage of the hard carbon film during service, thus permitting improvement of peeling resistance of the formed hard carbon film. Under the effect of the hard carbon film formed on the top and bottom surfaces, furthermore, it is possible to make it very difficult for cohesion to occur in the ring groove made of an Al alloy or steel. As a result, it is possible to provide a piston ring which is excellent in wear resistance and scuffing resistance, and has a function of inhibiting cohesion. The piston ring of the invention is thus applicable not only for gasoline engines, but also suitably applicable for high-output high-load diesel engines.

The entire disclosure of Japanese Patent Applications No.2001-098381 filed on Mar. 30, 2001, and No. 2001-232803 filed on Jul. 31, 2001 including the specification, claims, drawings, and summary are incorporated herein by reference in its entirety.

What is claimed is:

1. A piston ring wherein a hard carbon film containing one or more elements selected from the group consisting of Si, W and Ni is directly and continuously formed, via a primer film, on all the surfaces of a piston ring including an outer peripheral surface, an inner peripheral surface, a top surface and a bottom surface thereof.

2. A piston ring according to claim 1, wherein said hard carbon film contains Si, and an Si-containing film is formed as a primer film of said hard carbon film.

3. A piston ring according to claim 1, wherein said hard carbon film contains W or W—Ni, and a Cr film is formed as a primer film of said hard carbon film.

4. A piston ring according to any one of claims 1 to 3, wherein a hard film based on the ion plating process is formed as a primer film on at least the outer peripheral surface of the piston ring.

5. A combined structure of a piston ring and a ring groove, comprising a piston ring having a hard carbon film containing one or more elements selected from the group consisting of Si, W and Ni directly and continuously formed, via a primer film, on all the surfaces of a piston ring including an outer peripheral surface, an inner peripheral surface, a top surface and a bottom surface thereof, and a ring groove made of steel or an aluminum alloy.
